(19) United States
(12) Patent Application Publication
(10) Pub. No.: US 2026/0056382 A1
(43) Pub. Date: Feb. 26, 2026

(54) OPTICAL FIBER RIBBON AND METHOD FOR MANUFACTURING OPTICAL FIBER RIBBON

(71) Applicant: SUMITOMO ELECTRIC INDUSTRIES, LTD., Osaka (JP)

(72) Inventors: Hiroki ISHIKAWA, Osaka (JP); Itaru SAKABE, Osaka (JP); Reo AMANO, Osaka (JP); Kounan SHIN, Osaka (JP); Kenta TSUCHIYA, Osaka (JP); Toshihisa SATO, Osaka (JP)

(21) Appl. No.: 19/307,257

(22) Filed: Aug. 22, 2025

(30) Foreign Application Priority Data
Aug. 23, 2024 (JP) 2024-141938

(51) Int. Cl. G02B 6/44

(52) U.S. Cl. CPC G02B 6/4403; G02B 6/443; G02B 6/448

(57) ABSTRACT

An optical fiber ribbon includes: a plurality of optical fibers; and an adhesive resin coupling the plurality of optical fibers, in which the adhesive resin has viscosity higher than 35 mPa·s and lower than 147 mPa·s in at least a part of a temperature range from 50° C. to 75° C. before curing.

### TECHNICAL FIELD

The present disclosure relates to an optical fiber ribbon and a method for manufacturing an optical fiber ribbon. This application claims priority based on Japanese Patent Application No. 2024-141938 filed on Aug. 23, 2024, and the entire contents of which are incorporated herein by reference.

### BACKGROUND ART

In a related art, an optical fiber ribbon including a plurality of optical fibers has been developed. For example, JP2014-228688A discloses an intermittent optical fiber ribbon in which a plurality of optical fibers are arranged in a parallel row, and in which a coupling portion and a non-coupling portion are intermittently formed between adjacent optical fibers.

### SUMMARY

An optical fiber ribbon according to the present disclosure includes a plurality of optical fibers; and an adhesive resin coupling the plurality of optical fibers, in which the adhesive resin has viscosity higher than 35 mPa·s and lower than 147 mPa·s in at least a part of a temperature range from 50° C. to 75° C. before curing.

### BRIEF DESCRIPTION OF DRAWINGS

FIG. 1 is a diagram showing an optical fiber ribbon according to a first embodiment of the present disclosure.

FIG. 2A is a cross-sectional view of the optical fiber ribbon shown in FIG. 1.

FIG. 2B is a cross-sectional view of the optical fiber ribbon shown in FIG. 1.

FIG. 2C is a cross-sectional view of the optical fiber ribbon shown in FIG. 1.

FIG. 3 is a graph showing a correspondence relationship between temperature and viscosity of adhesive resin shown in FIG. 1 for each monomer content in the adhesive resin.

FIG. 4 is a diagram showing an optical fiber ribbon according to a modification of the first embodiment of the present disclosure.

FIG. 5A is a cross-sectional view of the optical fiber ribbon shown in FIG. 4.

FIG. 5B is a cross-sectional view of the optical fiber ribbon shown in FIG. 4.

FIG. 5C is a cross-sectional view of the optical fiber ribbon shown in FIG. 4.

FIG. 6 is a diagram showing an optical fiber ribbon according to a second embodiment of the present disclosure.

FIG. 7A is a cross-sectional view of the optical fiber ribbon shown in FIG. 6.

FIG. 7B is a cross-sectional view of the optical fiber ribbon shown in FIG. 6.

FIG. 7C is a cross-sectional view of the optical fiber ribbon shown in FIG. 6.

FIG. 8 is a diagram showing an optical fiber ribbon according to a modification of the second embodiment of the present disclosure.

FIG. 9 is a diagram showing an optical fiber ribbon according to a third embodiment of the present disclosure.

FIG. 10A is a cross-sectional view of the optical fiber ribbon shown in FIG. 9.

FIG. 10B is a cross-sectional view of the optical fiber ribbon shown in FIG. 9.

FIG. 10C is a cross-sectional view of the optical fiber ribbon shown in FIG. 9.

FIG. 11 is a diagram showing an optical fiber ribbon according to a fourth embodiment of the present disclosure.

FIG. 12A is a cross-sectional view of the optical fiber ribbon shown in FIG. 11.

FIG. 12B is a cross-sectional view of the optical fiber ribbon shown in FIG. 11.

FIG. 12C is a cross-sectional view of the optical fiber ribbon shown in FIG. 11.

FIG. 13 is a diagram showing measurement results of transmission loss and adhesive strength when viscosity of adhesive resin is changed for the optical fiber ribbons according to the first to fourth embodiments.

### DETAILED DESCRIPTION

Incidentally, when the viscosity of the adhesive resin used to bond the plurality of optical fibers to each other is high at the time of application, transmission loss of the optical fiber ribbon may increase due to factors such as swelling of the adhesive resin. On the other hand, when the viscosity of the adhesive resin is low at the time of application, the adhesive resin may spread thinly, resulting in a decrease in adhesive strength.

An object of the present disclosure is to provide an optical fiber ribbon and a method for manufacturing an optical fiber ribbon, which can reduce an increase in transmission loss and ensure adhesive strength between optical fibers.

According to the present disclosure, it is possible to reduce an increase in transmission loss and ensure adhesive strength between optical fibers.

### Description of Embodiments of Present Disclosure

First, embodiments of the present disclosure will be listed and described.

An optical fiber ribbon according to embodiments of the present disclosure includes:
(1) An optical fiber ribbon including: a plurality of optical fibers; and an adhesive resin coupling the plurality of optical fibers, in which the adhesive resin has viscosity higher than 35 mPa·s and lower than 147 mPa·s in at least a part of a temperature range from 50° C. to 75° C. before curing.

As described above, by the configuration of applying the adhesive resin having appropriate viscosity, it is possible to reduce an increase in transmission loss of the optical fiber ribbon by preventing the adhesive resin from swelling, and it is possible to prevent the adhesive resin from being spread thinly and ensure the adhesive strength between the optical fibers.
(2) In the optical fiber ribbon according to the above (1), the adhesive resin is a urethane acrylate-based ultraviolet curing resin and may contain 10 weight percent or more and 30 weight percent or less of a monomer.

With such a configuration, the viscosity of the adhesive resin in at least a part of the temperature range from 50° C. to 75° C. can be adjusted to be higher than 35 mPa·s and lower than 147 mPa·s.
(3) In the optical fiber ribbon according to the above (2), the monomer may be any one of isobornyl acrylate, N-vinylcaprolactam, 2-ethylhexyl acrylate, trimethylolpropane triacrylate, and acryloyl morpholine.

With such a configuration, the viscosity of the adhesive resin can be effectively adjusted.
(4) In the optical fiber ribbon according to any one of the above (1) to (3), the adhesive resin may be intermittently applied between adjacent optical fibers on one of two parallel surfaces formed by arranging the plurality of optical fibers in parallel.

With such a configuration, in the optical fiber ribbon in which the adhesive resin is intermittently provided on one of the two parallel surfaces, it is possible to achieve the optical fiber ribbon that reduces an increase in transmission loss and ensures the adhesive strength between the optical fibers.
(5) In the optical fiber ribbon according to any one of the above (1) to (3), the optical fiber ribbon includes a plurality of sub-ribbons each having two or more of the optical fibers, and the adhesive resin may be intermittently applied between adjacent ones of the plurality of sub-ribbons on one of two parallel surfaces formed by arranging the plurality of sub-ribbons in parallel.

With such a configuration, in the optical fiber ribbon in which the adhesive resin is intermittently provided on one of the two parallel surfaces, it is possible to achieve the optical fiber ribbon that reduces an increase in transmission loss and ensures the adhesive strength between the optical fibers of each sub-ribbon.
(6) In the optical fiber ribbon according to any one of the above (1) to (3), the adhesive resin may be continuously applied in a line shape to one of two parallel surfaces, which are formed by arranging the plurality of optical fibers in parallel, in a manner of reciprocating in a width direction of the parallel surfaces.

With such a configuration, in an intermittent type optical fiber ribbon in which the adhesive resin is continuously provided in a line shape on one of the two parallel surfaces formed by arranging the plurality of optical fibers in parallel, it is possible to achieve the optical fiber ribbon that reduces an increase in transmission loss and ensures the adhesive strength between the optical fibers.
(7) In the optical fiber ribbon according to any one of the above (1) to (3), the optical fiber ribbon includes a plurality of sub-ribbons each having two or more of the optical fibers, and the adhesive resin may be continuously applied in a line shape to one of two parallel surfaces, which are formed by arranging the plurality of sub-ribbons in parallel, in a manner of reciprocating in a width direction of the parallel surfaces.

With such a configuration, in an intermittent optical fiber ribbon made up of multiple cores, in which the adhesive resin is continuously provided in a line shape on one of the two parallel surfaces, it is possible to achieve the optical fiber ribbon that reduces an increase in transmission loss and ensures the adhesive strength between the optical fibers of each sub-ribbon.
(8) In the optical fiber ribbon according to any one of the above (1) to (3), the adhesive resin may be applied to entirety of the plurality of optical fibers, and the adhesive resin is intermittently removed between adjacent optical fibers.

With such a configuration, in an optical fiber ribbon in which the adhesive resin is provided over the entirety of the plurality of optical fibers and the adhesive resin is intermittently removed between the optical fibers adjacent to each other, it is possible to achieve the optical fiber ribbon that reduces an increase in transmission loss and ensures the adhesive strength between the optical fibers.
(9) In the optical fiber ribbon according to the above (4), the adhesive resin may be applied until reaching the other of the two parallel surfaces.

With such a configuration, in the optical fiber ribbon in which the adhesive resin is intermittently provided from one parallel surface to the other parallel surface, it is possible to achieve the optical fiber ribbon that reduces an increase in transmission loss and ensures the adhesive strength between the optical fibers.

A method for manufacturing an optical fiber ribbon according to embodiments of the present disclosure includes: (10) A method for manufacturing an optical fiber ribbon including a plurality of optical fibers, the method including: applying an adhesive resin for coupling the plurality of optical fibers in a state where viscosity of the adhesive resin is higher than 35 mPa·s and lower than 147 mPa·s.

As described above, by the method of applying the adhesive resin having appropriate viscosity, it is possible to reduce an increase in transmission loss of the optical fiber ribbon by preventing the adhesive resin from swelling, and it is possible to prevent the adhesive resin from being spread thinly and ensure the adhesive strength between the optical fibers.
(11) In the method for manufacturing an optical fiber ribbon according to the above (10), the adhesive resin may be intermittently applied between adjacent optical fibers on one of two parallel surfaces formed by arranging the plurality of optical fibers in parallel.

With such a method, for the optical fiber ribbon in which the adhesive resin is intermittently provided on one of the two parallel surfaces, it is possible to manufacture the optical fiber ribbon that reduces an increase in transmission loss and ensures the adhesive strength between the optical fibers.
(12) In the method for manufacturing an optical fiber ribbon according to the above (10), the optical fiber ribbon includes a plurality of sub-ribbons each having two or more of the optical fibers, and the adhesive resin may be intermittently applied between adjacent ones of the plurality of sub-ribbons on one of two parallel surfaces formed by arranging the plurality of sub-ribbons in parallel.

With such a method, for the optical fiber ribbon in which the adhesive resin is intermittently provided on one of the two parallel surfaces, it is possible to manufacture the optical fiber ribbon that reduces an increase in transmission loss and ensures the adhesive strength between the optical fibers of each sub-ribbon.
(13) In the method for manufacturing an optical fiber ribbon according to the above (10), the adhesive resin may be continuously applied in a line shape to one of two parallel surfaces formed by arranging the plurality of optical fibers in parallel while reciprocating in a width direction of the parallel surfaces.

With such a method, for an intermittent type optical fiber ribbon in which the adhesive resin is continuously provided in a line shape on one of the two parallel surfaces formed by arranging the plurality of optical fibers in parallel, it is possible to manufacture the optical fiber ribbon that reduces an increase in transmission loss and ensures the adhesive strength between the optical fibers.
(14) In the method for manufacturing an optical fiber ribbon according to the above (10), the optical fiber ribbon includes a plurality of sub-ribbons each having two or more of the optical fibers, and the adhesive resin may be continuously applied in a line shape to one of two parallel surfaces formed by arranging the plurality of sub-ribbons in parallel while reciprocating in a width direction of the parallel surfaces.

With such a method, for an intermittent optical fiber ribbon made up of multiple cores, in which the adhesive resin is continuously provided in a line shape on one of the two parallel surfaces, it is possible to manufacture the optical fiber ribbon that reduces an increase in transmission loss and ensures the adhesive strength between the optical fibers of each sub-ribbon.
(15) In the method for manufacturing an optical fiber ribbon according to the above (10), the adhesive resin may be applied to entirety of the plurality of optical fibers, and the adhesive resin is intermittently removed between adjacent optical fibers.

With such a method, for an optical fiber ribbon in which the adhesive resin is provided over the entirety of the plurality of optical fibers and the adhesive resin is intermittently removed between the optical fibers adjacent to each other, it is possible to manufacture the optical fiber ribbon that reduces an increase in transmission loss and ensures the adhesive strength between the optical fibers.
(16) In the method for manufacturing an optical fiber ribbon according to the above (10), the adhesive resin may be applied until reaching the other of the two parallel surfaces.

With such a method, in the optical fiber ribbon in which the adhesive resin is intermittently provided from one parallel surface to the other parallel surface, it is possible to manufacture the optical fiber ribbon that reduces an increase in transmission loss and ensures the adhesive strength between the optical fibers.

### Details of Embodiments of Present Disclosure

Specific examples of the optical fiber ribbon according to the present disclosure will be described below with reference to the drawings. The present invention is not limited to these exemplifications, but is indicated by the scope of claims, and is intended to include all modifications within a scope and meaning equivalent to the scope of claims.

### First Embodiment Example 1

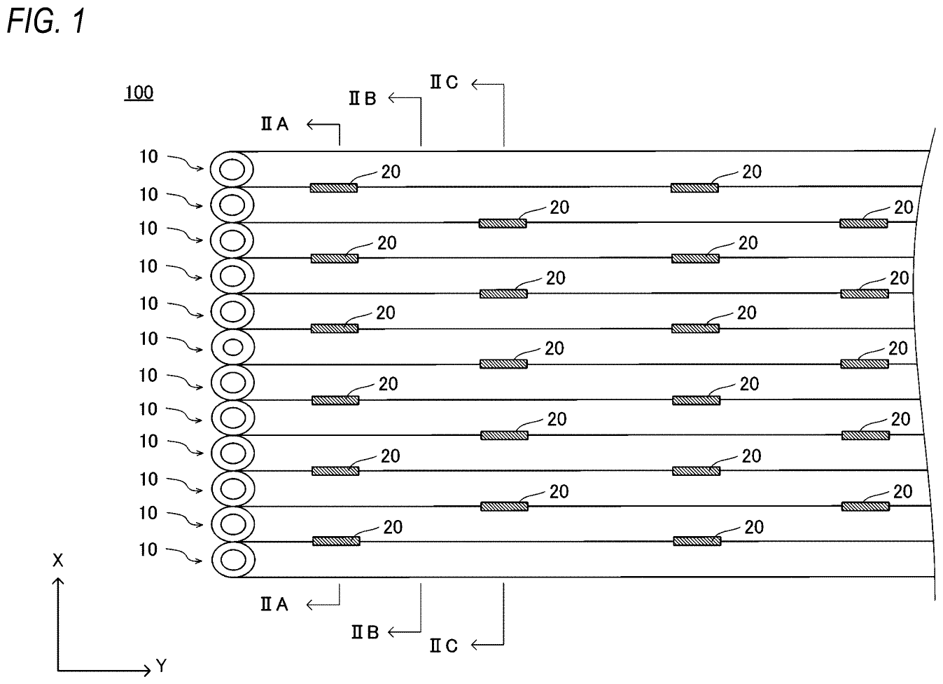

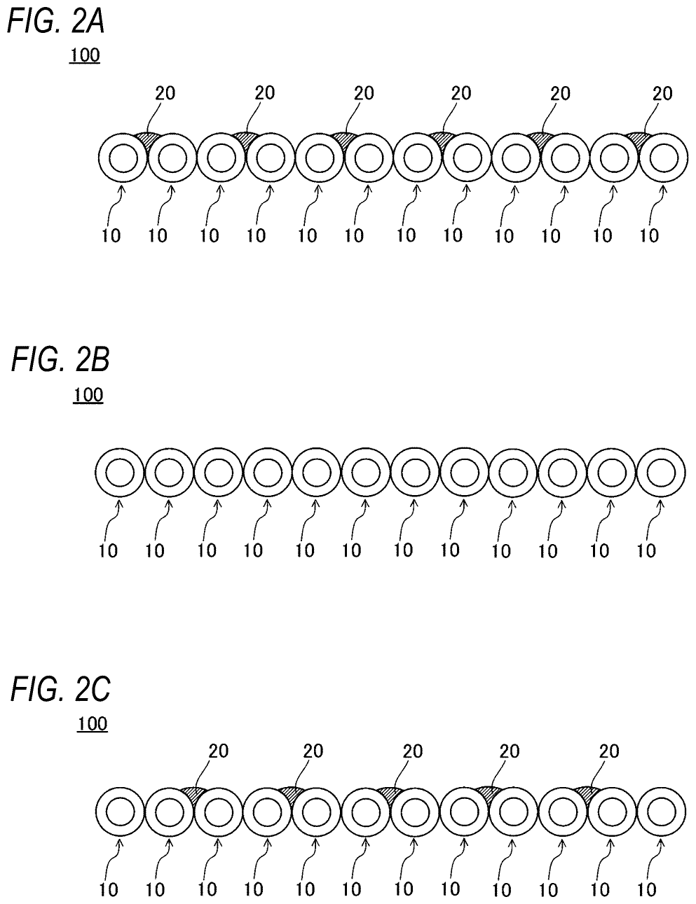

FIG. 1 is a diagram showing an optical fiber ribbon 100 according to a first embodiment of the present disclosure. FIGS. 2A to 2C are cross-sectional views of the optical fiber ribbon 100 shown in FIG. 1. More specifically, FIG. 2A is a cross-sectional view taken along line IIA-IIA shown in FIG. 1, FIG. 2B is a cross-sectional view taken along line IIB-IIB shown in FIG. 1, and FIG. 2C is a cross-sectional view taken along line IIC-IIC shown in FIG. 1.

Referring to FIGS. 1 and 2A to 2C, the optical fiber ribbon 100 includes a plurality of optical fibers 10 arranged in parallel and adhesive resin 20 coupling the plurality of optical fibers 10. In FIG. 1, as an example, the optical fiber ribbon 100 includes twelve optical fibers 10. Hereinafter, an extending direction of the optical fiber 10 is defined as a Y direction, and a direction in which the plurality of optical fibers 10 are arranged, that is, a width direction of the optical fiber ribbon 100 is defined as an X direction. Each optical fiber 10 is, for example, a single core fiber (SCF).

The adhesive resin 20 is applied so as to intermittently couple adjacent optical fibers 10. For example, the adhesive resin 20 is intermittently applied with a dispenser between outer peripheries of adjacent optical fibers 10 on one of two parallel surfaces formed by arranging the plurality of optical fibers 10 in parallel, and then is cured. The adhesive resin 20 is applied in a state where the viscosity is higher than 35 mPa·s and lower than 147 mPa·s in at least a part of a temperature range from 50° C. to 75° C. before curing.

More specifically, the adhesive resin 20 is a urethane acrylate-based ultraviolet curing resin, and is adjusted by adding a monomer so that the viscosity is higher than 35 mPa·s and lower than 147 mPa·s in at least a part of the temperature range from 50° C. to 75° C. The monomer contained in the adhesive resin 20 is isobornyl acrylate, N-vinylcaprolactam, 2-ethylhexyl acrylate, trimethylolpropane triacrylate, acryloyl morpholine, or the like.

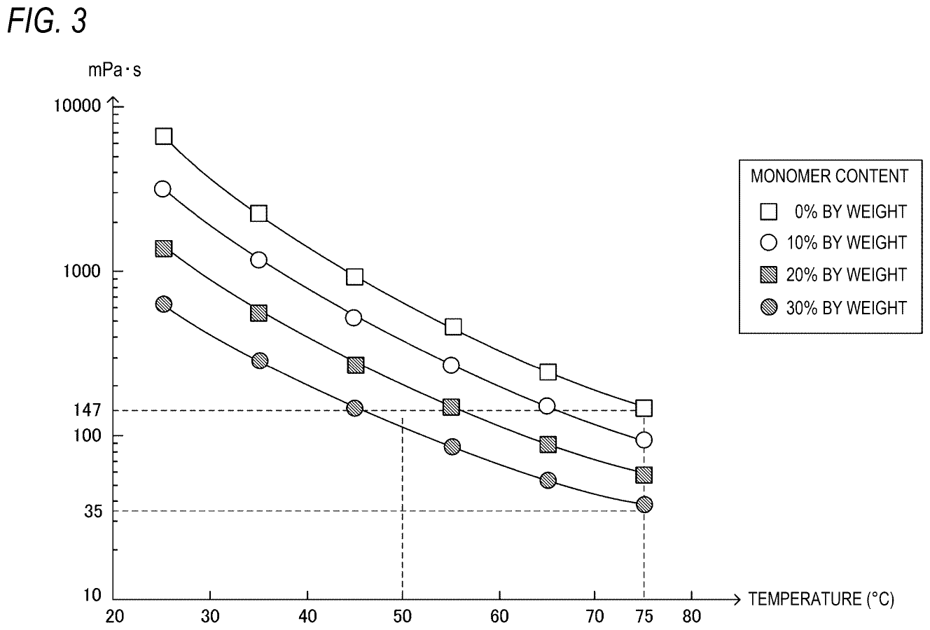

FIG. 3 is a graph showing a correspondence relationship between the temperature and the viscosity of the adhesive resin 20 shown in FIG. 1 for each monomer content in the adhesive resin 20. In the graph shown in FIG. 3, the vertical axis represents viscosity, and the horizontal axis represents temperature. Here, the relationship between the temperature and the viscosity of the adhesive resin 20 is shown when the monomer content of the adhesive resin 20 is 0 wt %, 10 wt %, 20 wt %, and 30 wt %.

As illustrated in FIG. 3, the viscosity of the adhesive resin 20 tends to decrease as the monomer content in the adhesive resin 20 increases. It can be seen that when the monomer content is in the range of 10% by weight to 30% by weight, the viscosity of the adhesive resin 20 can be easily adjusted to a range higher than 35 mPa·s and lower than 147 mPa·s in at least a part of the temperature range from 50° C. to 75° C. Therefore, the adhesive resin 20 is preferably adjusted so that the monomer content is 10 weight percent or more and 30 weight percent or less.

### Example 2

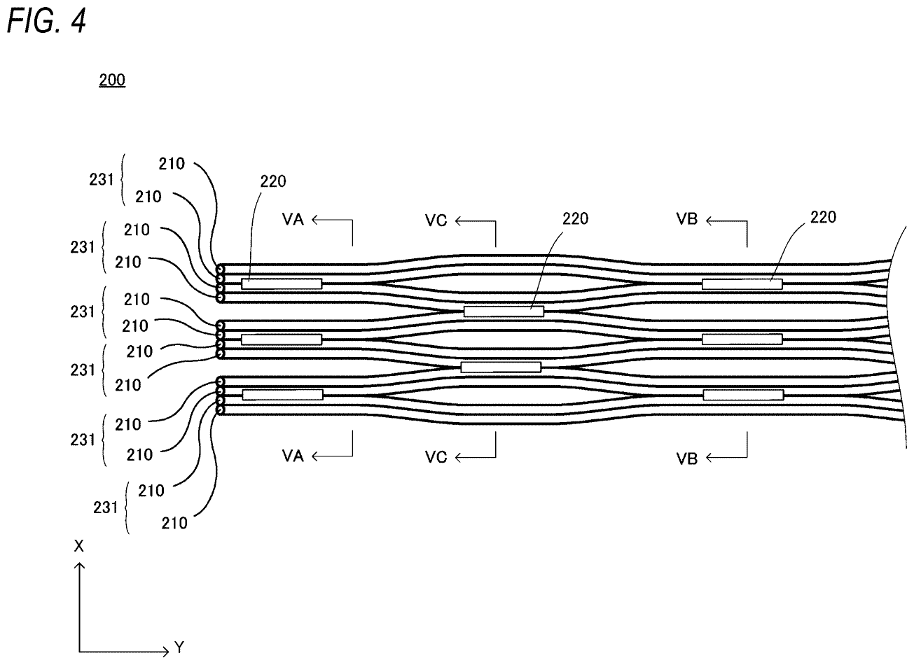

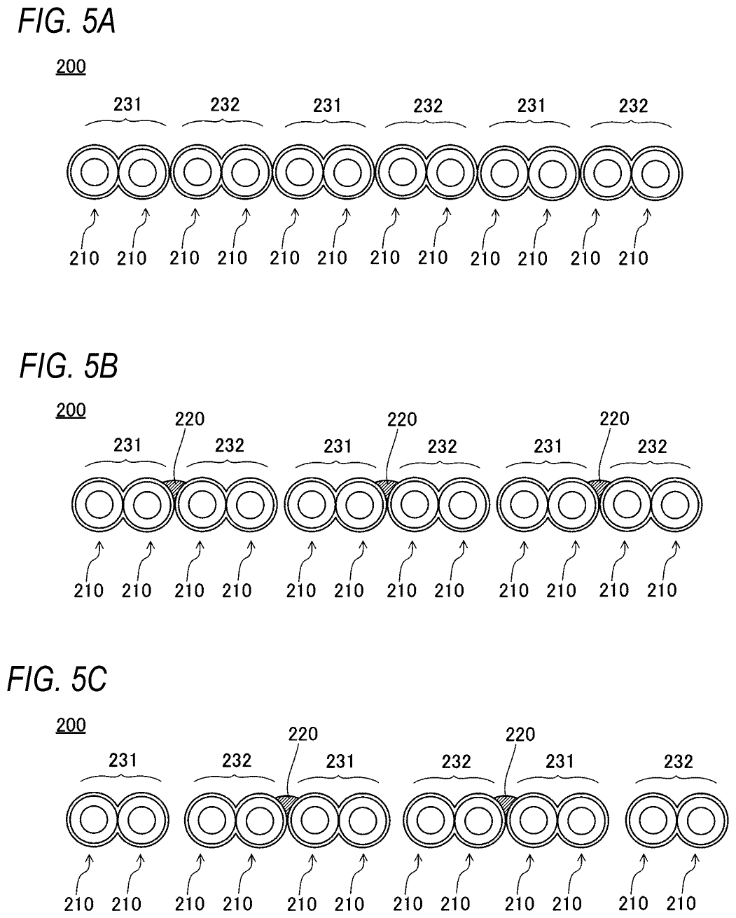

FIG. 4 is a diagram showing an optical fiber ribbon 200 according to a modification of the first embodiment of the present disclosure. FIGS. 5A to 5C are cross-sectional views of the optical fiber ribbon 200 shown in FIG. 4. More specifically, FIG. 5A is a cross-sectional view taken along line VA-VA shown in FIG. 4, FIG. 5B is a cross-sectional view taken along line VB-VB shown in FIG. 4, and FIG. 5C is a cross-sectional view taken along line VC-VC shown in FIG. 4.

Referring to FIGS. 4 and 5 A to 5C, the optical fiber ribbon 200 includes, for example, a plurality of sub-ribbons 231 each having two optical fibers 210. Adjacent optical fibers 210 included in one sub-ribbon 231 are coupled to each other over the entire length. The optical fiber ribbon 200 illustrated in FIG. 4 includes, for example, six sub-ribbons 231, and these six sub-ribbons 231 are arranged along the width direction (X direction illustrated in FIG. 4).

The number of optical fibers 210 included in each of the sub-ribbons 231 is not limited to two, and may be three or more.

The optical fiber ribbon 200 includes adhesive resin 220 that couples adjacent sub-ribbons 231. More specifically, the adhesive resin 220 is intermittently applied between the plurality of sub-ribbons 231 on one of two parallel surfaces formed by arranging the plurality of sub-ribbons 231 in parallel.

The adhesive resin 20 is formed of the same composition as the adhesive resin 20 shown in FIG. 1, and is applied using a dispenser or the like in a state where the viscosity is higher than 35 mPa·s and lower than 147 mPa·s in at least a part of the temperature range from 50° C. to 75° C. before curing.

### Second Embodiment Example 1

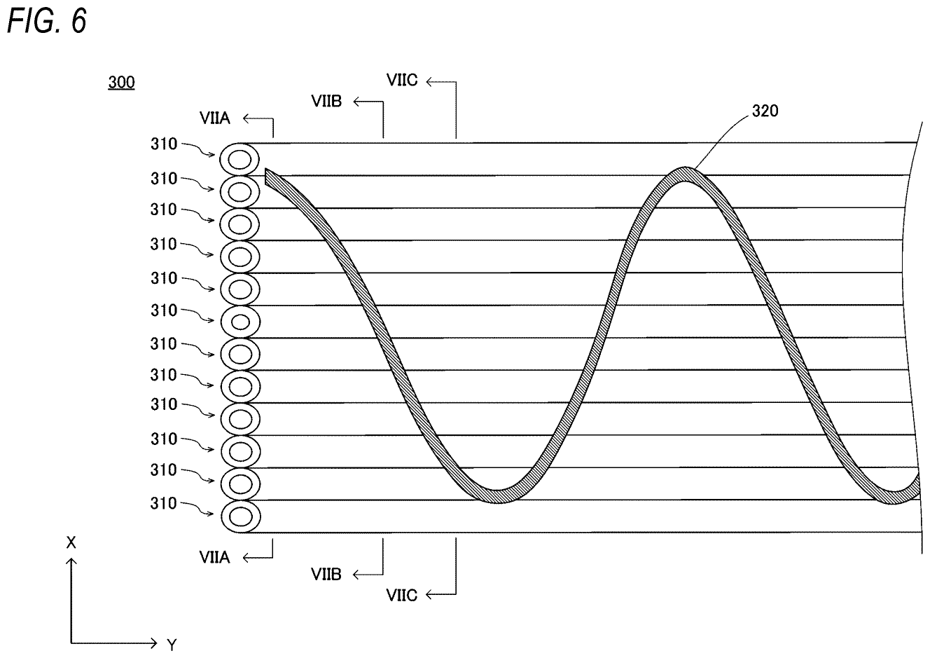

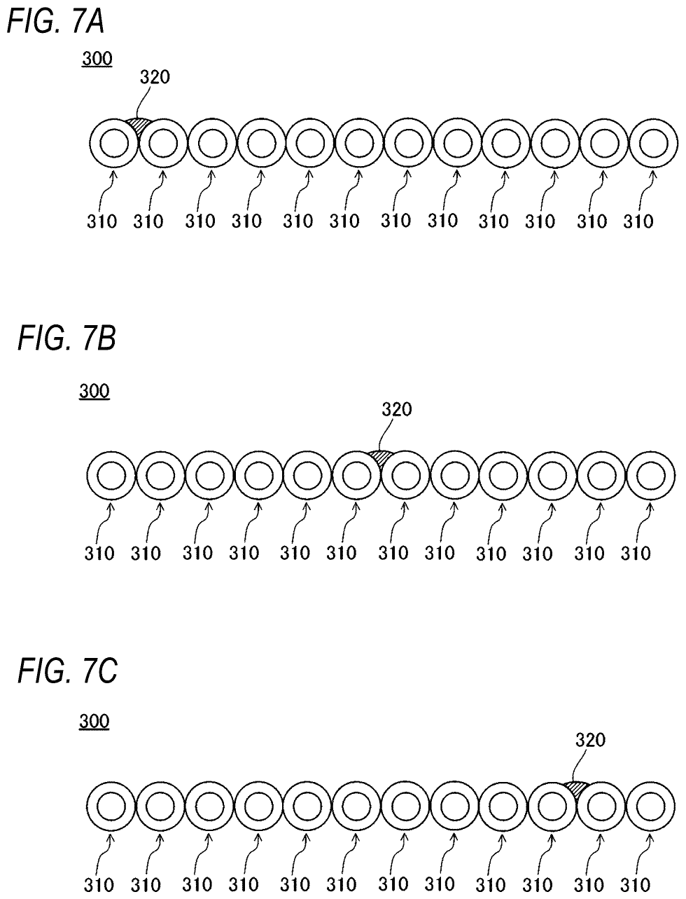

FIG. 6 is a diagram showing an optical fiber ribbon 300 according to a second embodiment of the present disclosure. FIGS. 7A to 7C are cross-sectional views of the optical fiber ribbon 300 shown in FIG. 6. More specifically, FIG. 7A is a cross-sectional view taken along line VIIA-VIIA shown in FIG. 6, FIG. 7B is a cross-sectional view taken along line VIIB-VIIB shown in FIG. 6, and FIG. 7C is a cross-sectional view taken along line VIIC-VIIC shown in FIG. 6.

Referring to FIGS. 6 and 7 A to 7C, similarly to the optical fiber ribbon 100 shown in FIG. 1, the optical fiber ribbon 300 includes a plurality of optical fibers 310 arranged in parallel and adhesive resin 320 coupling the plurality of optical fibers 310.

The adhesive resin 320 is continuously applied in a line shape to one of two parallel surfaces, which are formed by arranging the plurality of optical fibers 310 in parallel, in a manner of reciprocating in a width direction (X direction shown in FIG. 6) of the parallel surface. The adhesive resin 320 is formed of the same composition as the adhesive resin 20 shown in FIG. 1, and is applied using a dispenser or the like in a state where the viscosity is higher than 35 mPa·s and lower than 147 mPa·s in at least a part of the temperature range from 50° C. to 75° C. before curing.

### Example 2

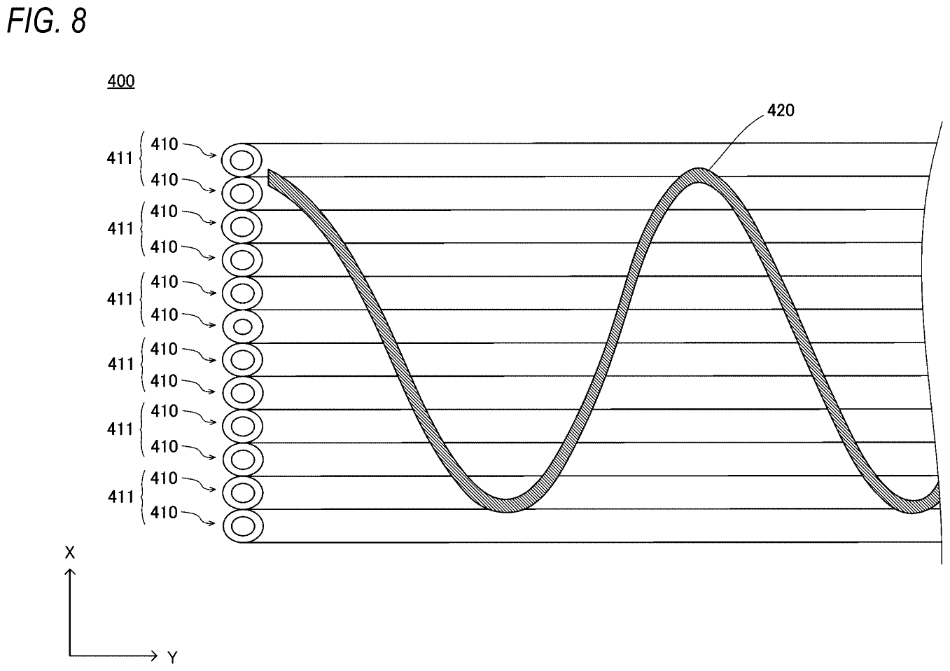

FIG. 8 is a diagram showing an optical fiber ribbon 400 according to a modification of the second embodiment of the present disclosure. The optical fiber ribbon 400 includes, for example, a plurality of sub-ribbons 411 each having two optical fibers 410. Adjacent optical fibers 410 included in one sub-ribbon 411 are coupled to each other over the entire length. The optical fiber ribbon 400 illustrated in FIG. 8 includes, for example, six sub-ribbons 411, and these six sub-ribbons 411 are arranged along the width direction (X direction illustrated in FIG. 8).

The number of optical fibers 410 included in each of the sub-ribbons 411 is not limited to two, and may be three or more.

The optical fiber ribbon 400 includes adhesive resin 420 that couples adjacent sub-ribbons 411. The adhesive resin 420 is continuously applied in a line shape to one of two parallel surfaces formed by arranging the plurality of sub-ribbons 411 in parallel so that the adhesive resin 420 reciprocates in a width direction (X direction shown in FIG. 8) of the parallel surface. The adhesive resin 420 is formed of the same composition as the adhesive resin 20 shown in FIG. 1, and is applied using a dispenser or the like in a state where the viscosity is higher than 35 mPa·s and lower than 147 mPa·s in at least a part of the temperature range from 50° C. to 75° C. before curing.

### Third Embodiment

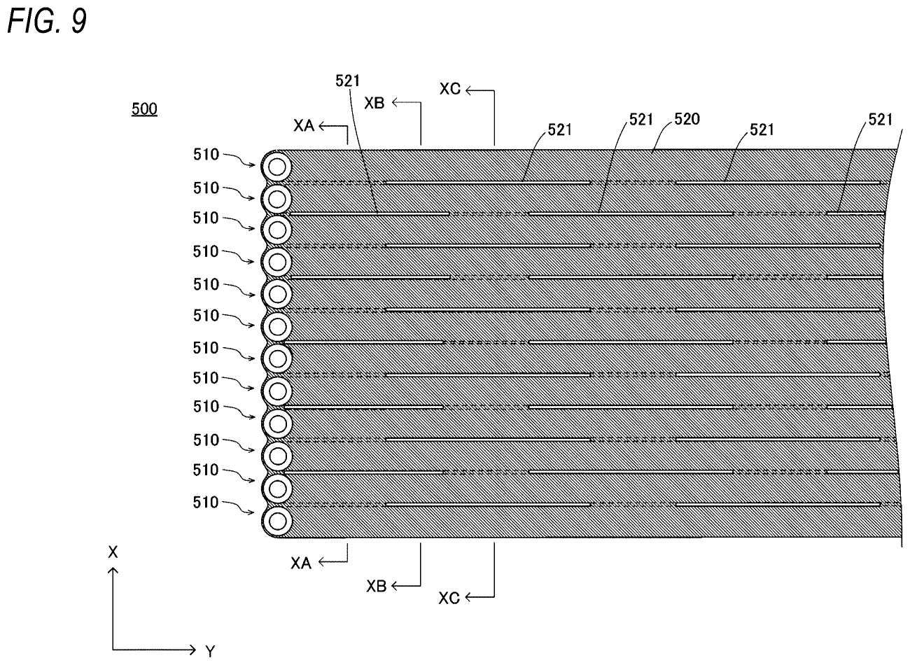

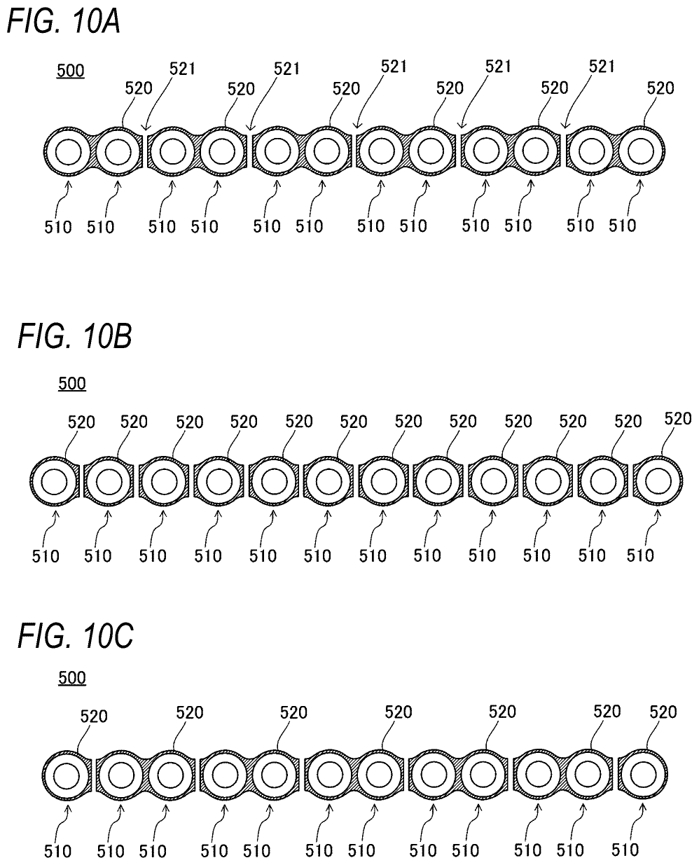

FIG. 9 is a diagram showing an optical fiber ribbon 500 according to a third embodiment of the present disclosure. FIGS. 10A to 10C are cross-sectional views of the optical fiber ribbon 500 shown in FIG. 9. More specifically, FIG. 10A is a cross-sectional view taken along line XA-XA shown in FIG. 9, FIG. 10B is a cross-sectional view taken along line XB-XB shown in FIG. 9, and FIG. 10C is a cross-sectional view taken along line XC-XC shown in FIG. 9.

Referring to FIGS. 9 and 10 A to 10C, similarly to the optical fiber ribbon 100 shown in FIG. 1, the optical fiber ribbon 500 includes a plurality of optical fibers 510 arranged in parallel and adhesive resin 520 coupling the plurality of optical fibers 510.

The adhesive resin 520 is applied to the entirety of the plurality of optical fibers 510, and then intermittently removed in a portion between adjacent optical fibers 510 along the Y direction, which is the extending direction of the optical fibers 510, to form slit portions 521. The adhesive resin 520 is formed of the same composition as the adhesive resin 20 shown in FIG. 1, and is applied in a state where the viscosity is higher than 35 mPa·s and lower than 147 mPa·s in at least a part of the temperature range from 50° C. to 75° C. before curing.

### Fourth Embodiment

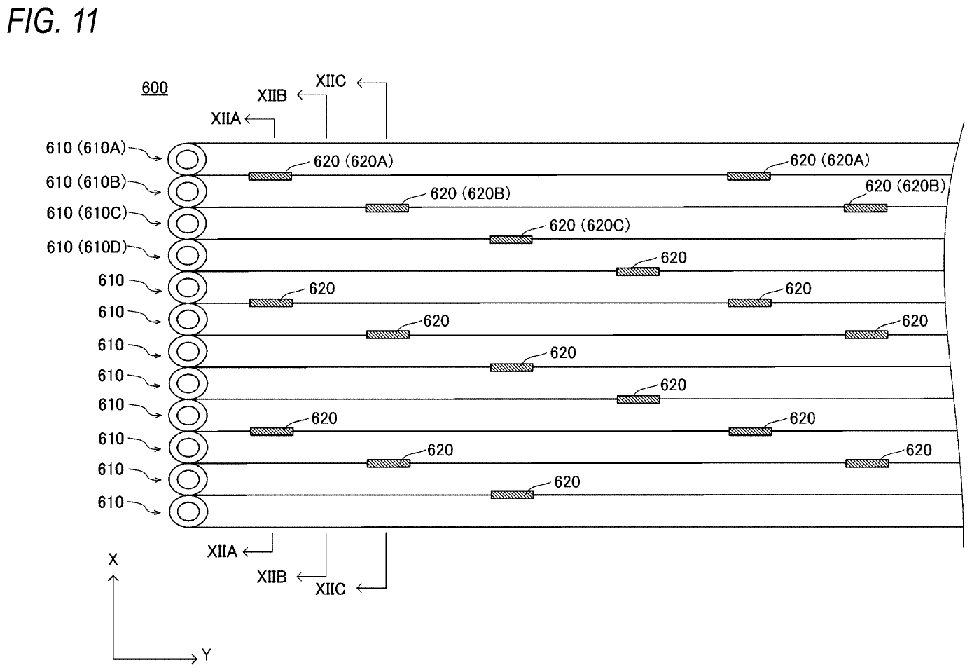

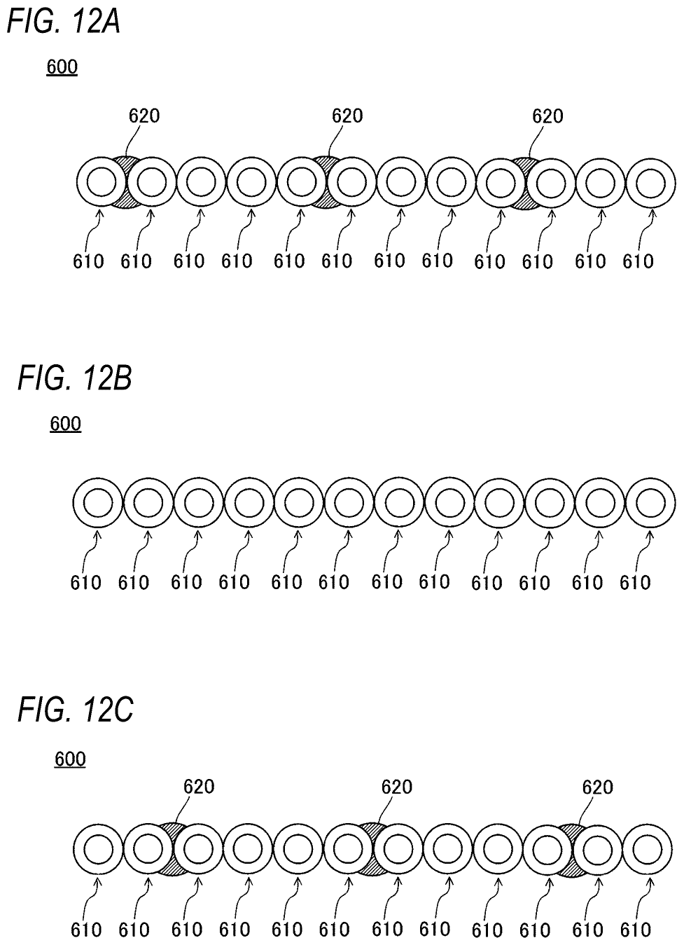

FIG. 11 is a diagram showing an optical fiber ribbon 600 according to a fourth embodiment of the present disclosure. FIGS. 12A to 12C are cross-sectional views of the optical fiber ribbon 600 shown in FIG. 11. More specifically, FIG. 12A is a cross-sectional view taken along line XIIA-XIIA shown in FIG. 11, FIG. 12B is a cross-sectional view taken along line XIIB-XIIB shown in FIG. 11, and FIG. 12C is a cross-sectional view taken along line XIIC-XIIC shown in FIG. 11.

Referring to FIGS. 11 and 12A to 12C, similarly to the optical fiber ribbon 100 shown in FIG. 1, the optical fiber ribbon 600 includes a plurality of optical fibers 610 arranged in parallel and adhesive resin 620 coupling the plurality of optical fibers 610.

The adhesive resin 620 is applied so as to intermittently couple adjacent optical fibers 610. As described above, the adhesive resin 20 (see FIG. 1) of the optical fiber ribbon 100 according to the first embodiment described above is intermittently applied to one of the two parallel surfaces formed by arranging the plurality of optical fibers 10 in parallel. On the other hand, as illustrated in FIGS. 12A and 12C, the adhesive resin 620 of the optical fiber ribbon 600 is applied until reaching the other of the two parallel surfaces formed by arranging the plurality of optical fibers 610 in parallel.

Further, as illustrated in FIG. 11, one of the plurality of optical fibers 610 is referred to as a first optical fiber 610A, and the optical fiber 610 adjacent to the first optical fiber 610A is referred to as a second optical fiber 610B. Further, the optical fiber 610 adjacent to the second optical fiber 610B and different from the first optical fiber 610A is referred to as a third optical fiber 610C, and the optical fiber 610 adjacent to the third optical fiber 610C and different from the second optical fiber 610B is referred to as a fourth optical fiber 610D.

The adhesive resin 620 coupling the first optical fiber 610A and the second optical fiber 610B is referred to as first adhesive resin 620A, the adhesive resin 620 coupling the second optical fiber 610B and the third optical fiber 610C is referred to as second adhesive resin 620B, and the adhesive resin 620 coupling the third optical fiber 610C and the fourth optical fiber 610D is referred to as third adhesive resin 620C.

In this case, the first adhesive resin 620A, the second adhesive resin 620B, and the third adhesive resin 620C are applied at different positions from each other in the Y direction, which is the extending direction of the optical fiber 610.

The adhesive resin 620 including the first adhesive resin 620A, the second adhesive resin 620B, and the third adhesive resin 620C is formed of the same composition as the adhesive resin 20 shown in FIG. 1, and is applied in a state where the viscosity is higher than 35 mPa·s and lower than 147 mPa·s in at least a part of the temperature range from 50° C. to 75° C. before curing.

### Experimental Results of Transmission Loss and Adhesive Strength

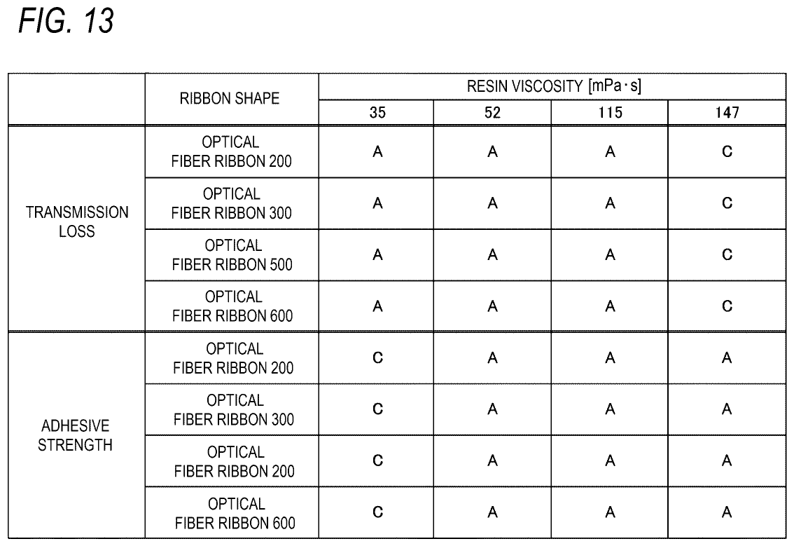

FIG. 13 is a diagram showing measurement results of transmission loss and adhesive strength when viscosity of the adhesive resin is changed for the optical fiber ribbons 200, 300, 500, and 600 according to the first to fourth embodiments. Here, regarding the optical fiber ribbon 200 according to the first embodiment, the optical fiber ribbon 300 according to the second embodiment, the optical fiber ribbon 500 according to the third embodiment, and the optical fiber ribbon 600 according to the fourth embodiment, the measurement results of the transmission loss and the adhesive strength when the viscosity of the adhesive resin is changed in the temperature range from 50° C. to 75° C. before curing will be described.

Each of the optical fiber ribbons 200, 300, 500, and 600 includes twelve optical fibers 210, 310, 510, and 610, respectively. When such optical fiber ribbons 200, 300, 500, and 600 were wound on a bobbin, the transmission loss per 1 km was measured. In the table shown in FIG. 13, a transmission loss value less than 0.25 dB is rated as A, and a transmission loss value equal to or greater than 0.25 dB is rated as C.

As shown in FIG. 13, in all the optical fiber ribbons 200, 300, 500, and 600, when the viscosity of the adhesive resin was in the range of 35 mPa·s to 115 mPa·s, the transmission loss value was less than 0.25 dB. On the other hand, in all the optical fiber ribbons 200, 300, 500, and 600, when the viscosity of the adhesive resin was 147 mPa·s, the transmission loss value was 0.25 dB or more. From these results, it can be seen that in order to reduce an increase in the transmission loss of the optical fiber ribbons 200, 300, 500, and 600, the viscosity of the adhesive resin is preferably lower than 147 mPa·s.

Further, the adhesive strength between the optical fibers in the optical fiber ribbons 200, 300, 500, and 600 was measured. Here, for each of the optical fiber ribbons 200, 300, 500, and 600, two optical fibers coupled by the adhesive resin were gripped and torn apart at a speed of 200 mm/min, and the load was measured. In the table shown in FIG. 13, a load equal to or greater than 0.025 N is rated as A, and a load less than 0.025 N is rated as C.

As shown in FIG. 13, in all the optical fiber ribbons 200, 300, 500, and 600, when the viscosity of the adhesive resin was in the range of 52 mPa·s to 147 mPa·s, the load was equal to or greater than 0.025 N, and the adhesive strength was high. On the other hand, in all the optical fiber ribbons 200, 300, 500, and 600, when the viscosity of the adhesive resin was 35 mPa·s, the load was less than 0.025 N, and the adhesive strength was low. From these results, it can be seen that in order to ensure the adhesive strength between the optical fibers in the optical fiber ribbons 200, 300, 500, and 600, the viscosity of the adhesive resin is preferably higher than 35 mPa·s.

From the above measurement results, it can be seen that in order to reduce an increase in the transmission loss of the optical fiber ribbons 200, 300, 500, and 600 and ensure the adhesive strength between the optical fibers, the viscosity of the adhesive resin is preferably higher than 35 mPa·s and lower than 147 mPa·s. That is, in any of the optical fiber ribbons according to the first to fourth embodiments described above, when the viscosity of the adhesive resin is higher than 35 mPa·s and lower than 147 mPa·s in at least a part of the temperature range from 50° C. to 75° C. before curing, it is possible to more reliably reduce an increase in the transmission loss of the optical fiber ribbon and ensure the adhesive strength between the optical fibers.

The present disclosure has been described above based on the specific embodiments. However, the present invention is not limited to these exemplifications, but is indicated by the scope of claims, and is intended to include all modifications within a scope and meaning equivalent to the scope of claims.

What is claimed is:

1. An optical fiber ribbon comprising:
a plurality of optical fibers; and
an adhesive resin coupling the plurality of optical fibers,
wherein the adhesive resin has viscosity higher than 35 mPa·s and lower than 147 mPa·s in at least a part of a temperature range from 50° C. to 75° C. before curing.

2. The optical fiber ribbon according to claim 1, wherein the adhesive resin is a urethane acrylate-based ultraviolet curing resin and contains 10 weight percent or more and 30 weight percent or less of a monomer.

3. The optical fiber ribbon according to claim 2, wherein the monomer is any one of isobornyl acrylate, N-vinylcaprolactam, 2-ethylhexyl acrylate, trimethylolpropane triacrylate, and acryloyl morpholine.

4. The optical fiber ribbon according to claim 1, wherein the adhesive resin is intermittently applied between adjacent optical fibers on one of two parallel surfaces formed by arranging the plurality of optical fibers in parallel.

5. The optical fiber ribbon according to claim 1,
wherein the optical fiber ribbon includes a plurality of sub-ribbons each including two or more of the optical fibers, and
wherein the adhesive resin is intermittently applied between adjacent ones of the plurality of sub-ribbons on one of two parallel surfaces formed by arranging the plurality of sub-ribbons in parallel.

6. The optical fiber ribbon according to claim 1, wherein the adhesive resin is continuously applied in a line shape to one of two parallel surfaces, which are formed by arranging the plurality of optical fibers in parallel, in a manner of reciprocating in a width direction of the one of two parallel surfaces.

7. The optical fiber ribbon according to claim 1,
wherein the optical fiber ribbon includes a plurality of sub-ribbons each having two or more of the optical fibers, and
wherein the adhesive resin is continuously applied in a line shape to one of two parallel surfaces, which are formed by arranging the plurality of sub-ribbons in parallel, in a manner of reciprocating in a width direction of the one of two parallel surfaces.

8. The optical fiber ribbon according to claim 1,
wherein the adhesive resin is applied to entirety of the plurality of optical fibers, and
wherein the adhesive resin is intermittently removed between adjacent optical fibers.

9. The optical fiber ribbon according to claim 4, wherein the adhesive resin is applied until reaching the other of the two parallel surfaces.

10. A method for manufacturing an optical fiber ribbon including a plurality of optical fibers, the method comprising
applying an adhesive resin for coupling the plurality of optical fibers in a state where viscosity of the adhesive resin is higher than 35 mPa·s and lower than 147 mPa·s.

11. The method for manufacturing an optical fiber ribbon according to claim 10, wherein the adhesive resin is intermittently applied between adjacent optical fibers on one of two parallel surfaces formed by arranging the plurality of optical fibers in parallel.

12. The method for manufacturing an optical fiber ribbon according to claim 10,
wherein the optical fiber ribbon includes a plurality of sub-ribbons each having two or more of the optical fibers, and
wherein the adhesive resin is intermittently applied between adjacent ones of the plurality of sub-ribbons on one of two parallel surfaces formed by arranging the plurality of sub-ribbons in parallel.

13. The method for manufacturing an optical fiber ribbon according to claim 10, wherein the adhesive resin is continuously applied in a line shape to one of two parallel surfaces formed by arranging the plurality of optical fibers in parallel while reciprocating in a width direction of the one of two parallel surfaces.

14. The method for manufacturing an optical fiber ribbon according to claim 10,
wherein the optical fiber ribbon includes a plurality of sub-ribbons each having two or more of the optical fibers, and
wherein the adhesive resin is continuously applied in a line shape to one of two parallel surfaces formed by arranging the plurality of sub-ribbons in parallel while reciprocating in a width direction of the one of two parallel surfaces.

15. The method for manufacturing an optical fiber ribbon according to claim 10,
wherein the adhesive resin is applied to entirety of the plurality of optical fibers, and
wherein the adhesive resin is intermittently removed between adjacent optical fibers.

16. The method for manufacturing an optical fiber ribbon according to claim 11, wherein the adhesive resin is applied until reaching the other of the two parallel surfaces.
